(19) United States
(12) Patent Application Publication
(10) Pub. No.: US 2025/0005432 A1
(43) Pub. Date: Jan. 2, 2025

(54) INTENT SUGGESTION RECOMMENDATION FOR ARTIFICIAL INTELLIGENCE SYSTEMS

(71) Applicant: International Business Machines Corporation, Armonk, NY (US)

(72) Inventors: Haode Qi, Cambridge, MA (US); Eric Donald Wayne, Raleigh, NC (US); Gengyu Wang, Long Island City, NY (US); Ella Rabinovich, Hod Hasharon (IL)

(21) Appl. No.: 18/216,700

(22) Filed: Jun. 30, 2023

(51) Int. Cl. G06N 20/00; G06N 5/04

(52) U.S. Cl. CPC G06N 20/00; G06N 5/04

(57) ABSTRACT

A first intent from customer provided data is encoded as an intent embedding and the intent embedding of the first intent and an intent embedding corresponding to one or more items of a training workspace are compared to generate a similarity score. The first intent is mapped to a similar item of the one or more items and a corresponding count of the similar item is incremented by one in response to the similarity score being greater than a given threshold. A matrix is created based on the similarity score. At least a first machine learning model is trained using one or more of the training workspaces of the created matrix; at least a second machine learning model is trained using the created matrix; and deployment of the at least second machine learning model is facilitated for performing inferencing.

### BACKGROUND

The present invention relates generally to the electrical, electronic and computer arts and, more particularly, to machine learning and artificial intelligence systems.

Conversational artificial intelligence (AI) services rely on manually curated training data to train an AI agent. Manual data creation can be a tedious process, in terms of both creating new utterance examples, and introducing new intents. Real customer logs are a viable source of new utterance data and intents and conventional training solutions often focus on intent candidate mining of these logs using approaches such as clustering. Intent candidates produced by conventional techniques are often overlapping and are not customized for customer preference and domain. Extensive manual work is required to shape intent candidates into effective training for an AI agent. This limits the usage of log data and results in untapped potential.

### BRIEF SUMMARY

Principles of the invention provide systems and techniques for an intent suggestion recommendation service for artificial intelligence systems. In one aspect, an exemplary method includes the operations of encoding, using at least one hardware processor, a first intent from customer provided data as an intent embedding; comparing, using the at least one hardware processor, the intent embedding of the first intent and an intent embedding corresponding to one or more items of a training workspace to generate a similarity score; mapping, using the at least one hardware processor, the first intent to a similar item of the one or more items and incrementing a corresponding count of the similar item by one in response to the similarity score being greater than a given threshold; creating, using the at least one hardware processor, a matrix based on the similarity score, the created matrix including selected training workspaces; training, using the at least one hardware processor, at least a first machine learning model using one or more of the training workspaces of the created matrix; training, using the at least one hardware processor, at least a second machine learning model using the created matrix; and facilitating, using the at least one hardware processor, deployment of the at least second machine learning model for performing inferencing.

In one aspect, a computer program product comprises one or more tangible computer-readable storage media and program instructions stored on at least one of the one or more tangible computer-readable storage media, the program instructions executable by a processor, the program instructions comprising encoding a first intent from customer provided data as an intent embedding; comparing the intent embedding of the first intent and an intent embedding corresponding to one or more items of a training workspace to generate a similarity score; mapping the first intent to a similar item of the one or more items and incrementing a corresponding count of the similar item by one in response to the similarity score being greater than a given threshold; creating a matrix based on the similarity score, the created matrix including selected training workspaces; training at least a first machine learning model using one or more of the training workspaces of the created matrix; training, using the at least one hardware processor, at least a second machine learning model using the created matrix; and facilitating deployment of the at least second machine learning model for performing inferencing.

In one aspect, an apparatus comprises a memory and at least one processor, coupled to the memory, and operative to perform operations comprising encoding a first intent from customer provided data as an intent embedding; comparing the intent embedding of the first intent and an intent embedding corresponding to one or more items of a training workspace to generate a similarity score; mapping the first intent to a similar item of the one or more items and incrementing a corresponding count of the similar item by one in response to the similarity score being greater than a given threshold; creating a matrix based on the similarity score, the created matrix including selected training workspaces; training at least a first machine learning model using one or more of the training workspaces of the created matrix; training, using the at least one hardware processor, at least a second machine learning model using the created matrix; and facilitating deployment of the at least second machine learning model for performing inferencing.

As used herein, “facilitating” an action includes performing the action, making the action easier, helping to carry the action out, or causing the action to be performed. Thus, by way of example and not limitation, instructions executing on a processor might facilitate an action carried out by instructions executing on a remote processor, by sending appropriate data or commands to cause or aid the action to be performed. Where an actor facilitates an action by other than performing the action, the action is nevertheless performed by some entity or combination of entities.

Techniques as disclosed herein can provide substantial beneficial technical effects. Some embodiments may not have these potential advantages and these potential advantages are not necessarily required of all embodiments. By way of example only and without limitation, one or more embodiments may provide one or more of:
intent recommendation system customized according to customer preferences and domains;
improves the technological process of machine learning by generating improved machine learning models via expanded training datasets;
improved machine learning models by eliminating overlapping intent candidates from expanded model training datasets;
improved machine learning models by identifying new intents from user logs to expand the model training datasets;
methods for creating an item-to-customer matrix based on a mapping between customer intents and a customer workspace (multiple intents could be mapped to the same item to eliminate overlapping intents);
an item-to-customer matrix that serves as the knowledge base for generation of intent recommendations (log data from a customer is clustered into distinct clusters and mapped into a proposed item using the item-to-customer matrix; if the proposed item presents in the most similar Top K workspaces in the item-to-customer matrix, the proposed item will be presented for final recommendation); and
an item-to-customer matrix that can be embedded into item embeddings that can be used to train an item classifier (log data from a customer is classified into distinct items using an item classifier; if the number of logs is greater than n for a particular item, the item will be kept as a candidate for recommendation. The workspace will be embedded into workspace embeddings and the final ranking of the candidates will be decided by the similarity between the workspace embeddings and the item embeddings).

These and other features and advantages will become apparent from the following detailed description of illustrative embodiments thereof, which is to be read in connection with the accompanying drawings.

### BRIEF DESCRIPTION OF THE DRAWINGS

The following drawings are presented by way of example only and without limitation, wherein like reference numerals (when used) indicate corresponding elements throughout the several views, and wherein:

FIG. 1 is a table showing a simplified example of manually curated training data for training an AI agent;

FIG. 2 is a high-level block diagram of a recommendation AI system, in accordance with an example embodiment;

FIG. 3 is an example method for creating the matrix M based on a mapping between the customer intents and a customer workspace(s), in accordance with example embodiments;

FIG. 4A is an example matrix M illustrating a grouping of intents, such as intent 1, intent 2, intent 3, and intent 4, into corresponding items for a corresponding training workspace, in accordance with example embodiments;

FIG. 4B is an example matrix M showing the counts of corresponding items for each corresponding training workspace following the building of the training portion of the matrix, in accordance with example embodiments;

FIG. 5 is an example method for generating a recommendation for an intent, in accordance with example embodiments;

FIG. 6 is an example of a built matrix M being updated with a grouping of intents into corresponding items for a corresponding client workspace, in accordance with example embodiments;

FIG. 7 shows results of grouping the user utterances of the client log data and mapping the clusters into items of the similar training workspaces, in accordance with example embodiments;

FIG. 8 illustrates an overall workflow for generating recommendations of intents, in accordance with example embodiments; and

FIG. 9 depicts a computing environment according to an embodiment of the present invention.

It is to be appreciated that elements in the figures are illustrated for simplicity and clarity. Common but well-understood elements that may be useful or necessary in a commercially feasible embodiment may not be shown in order to facilitate a less hindered view of the illustrated embodiments.

### DETAILED DESCRIPTION

Principles of inventions described herein will be in the context of illustrative embodiments. Moreover, it will become apparent to those skilled in the art given the teachings herein that numerous modifications can be made to the embodiments shown that are within the scope of the claims. That is, no limitations with respect to the embodiments shown and described herein are intended or should be inferred.

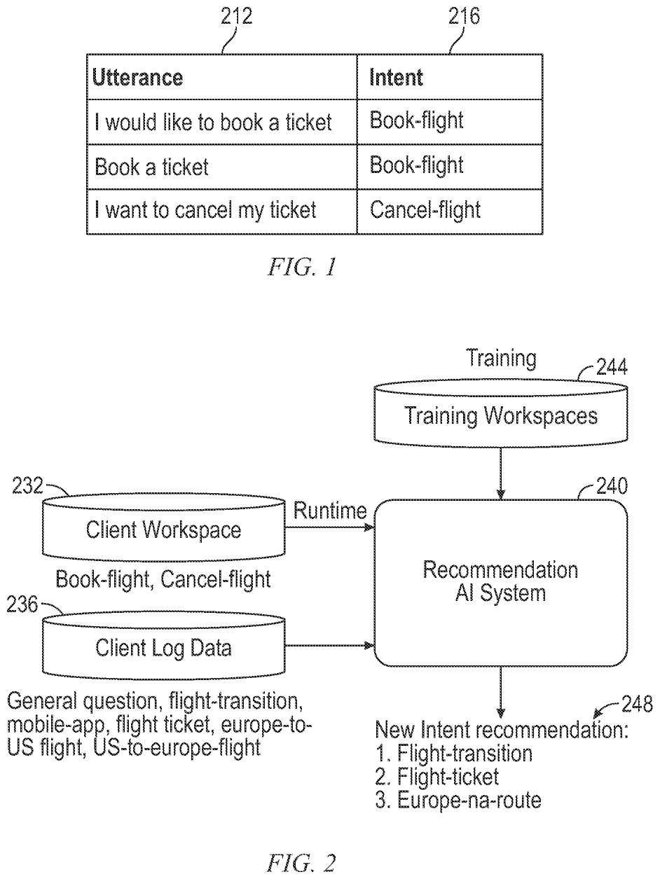

One or more embodiments provide techniques for identifying new intents from customer provided data, user logs, and the like. In example embodiments, intents (including well-defined intents) are recommended based on characteristics of a customer workspace. As used herein, a “workspace” is a dataset including pairs of utterances labeled with intents used, for example, for training an AI agent and “user logs” are the data sent by end users that interact with, for example, the AI agent. FIG. 1 is a table showing a simple example of manually curated training data for training an AI agent. The three example utterances 212 and corresponding intents 216 were manually curated by an individual.

FIG. 2 is a high-level block diagram of a recommendation AI system 240, in accordance with an example embodiment. The recommendation AI system 240 is trained using training workspaces 244. In one example embodiment, the training is performed offline. At runtime, client workspace(s) 232 and client log data 236 are processed by the recommendation AI system 240 to generate new intent recommendations 248. For example, new intent recommendations 248, such as flight-transition, flight-ticket, and Europe-to-US, may be generated.

### Training a Customer Item Matrix

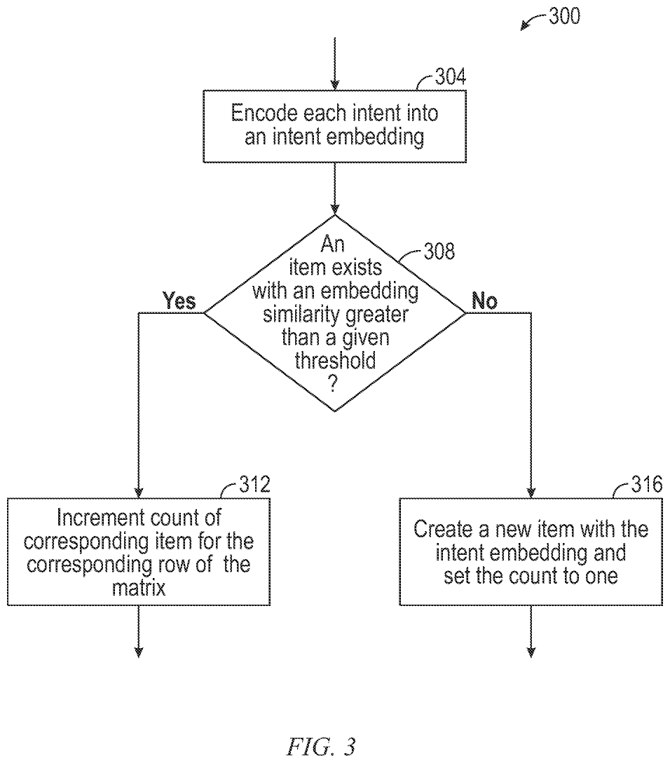

In one example embodiment, for customer provided training workspaces 244, a mapping is created between customer intents 216 and a customer workspace(s) 232. For a given training workspace 244, a matrix M is created based on the mapping. In one example embodiment, the matrix is created for a plurality of training workspaces 244. FIG. 3 is an example method 300 for creating the matrix M based on a mapping between the customer intents 216 and a customer workspace(s) 232, in accordance with example embodiments. In one example embodiment, each intent is encoded into an intent_embeddingᵢ (such as, a mean embedding of all sentences) (operation 304). A check is performed to determine is there exists an existing item; with a similarity (intent_embeddingᵢ, item_embeddingⱼ) that is greater than a given threshold (operation 308). If there exists an existing item; with a similarity (intent_embeddingᵢ, item_embeddingⱼ) that is greater than the given threshold (YES branch of decision block 308), the count of item; for the corresponding row of this training workspace 244 is incremented by one (operation 312); otherwise (NO branch of decision block 308), a new itemₖ is created with the intent embedding (intent_embeddingᵢ of the intentᵢ) as the intent embedding of the new itemₖ and the count of the new item is set to one (operation 316). (Note: in one or more embodiments, the final matrix is built with items and an item can represent more than one intent 216 if there is a significant overlap in the semantics in the intents 216.)

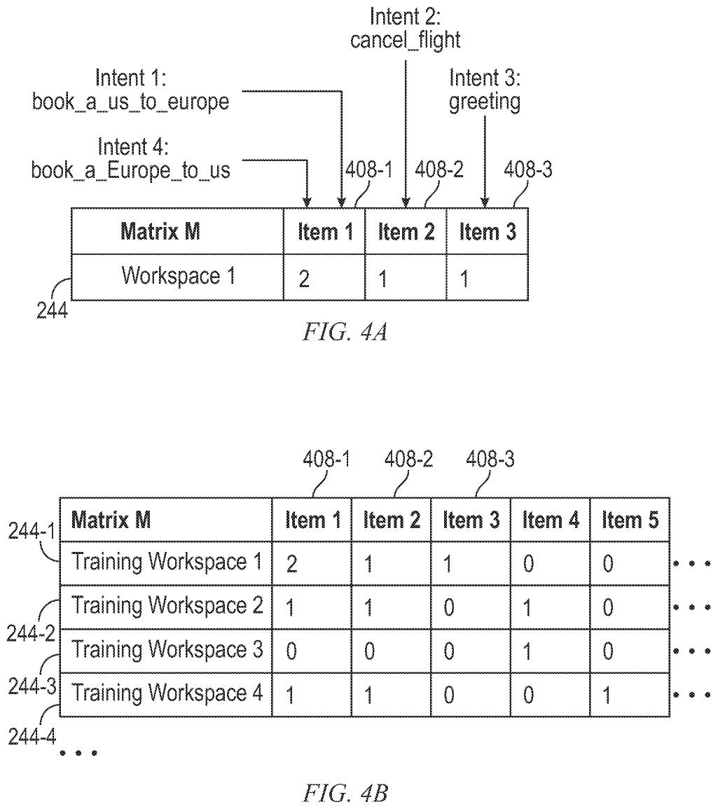

FIG. 4A is an example matrix M illustrating a grouping of intents 216, such as intent 1, intent 2, intent 3, and intent 4, into corresponding items 408-1, 408-2, 408-3 for a corresponding training workspace 244-1, 244-2, 244-3, 244-4, in accordance with example embodiments. As illustrated in FIG. 4A, intent 1 and intent 4 are grouped together for item 1 (item 408-1), intent 2 is grouped into item 2 (item 408-2), and intent 3 is grouped into item 3 (item 408-3).

Operations 304-312 are repeated for each training workspace 244 and a matrix M is created for the pairs of training workspace 244-1, 244-2, 244-3, 244-4 and item 408-1, 408-2, 408-3. The matrix M is filled by the counts of intents 216 corresponding to each item 408-1, 408-2, 408-3 for each corresponding training workspace 244-1, 244-2, 244-3, 244-4. FIG. 4B is an example matrix M showing the counts of corresponding items 408-1, 408-2, 408-3 for each corresponding training workspace 244-1, 244-2, 244-3 following the building of the training portion of the matrix, in accordance with example embodiments.

### Runtime Recommendation

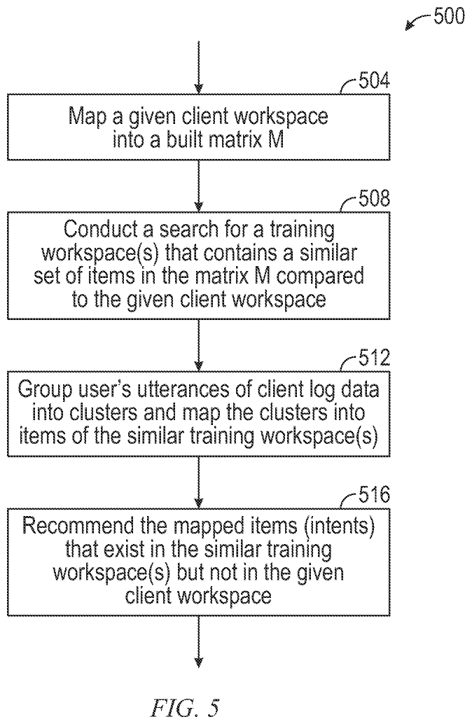

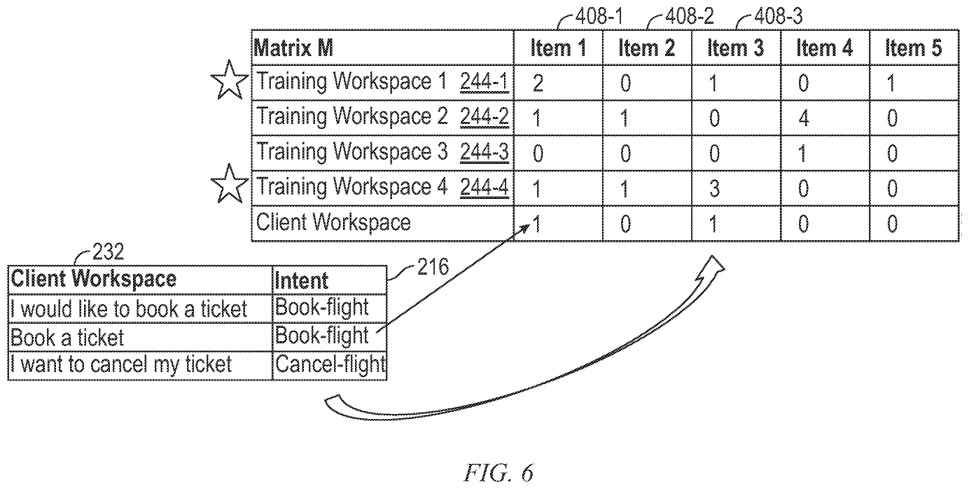

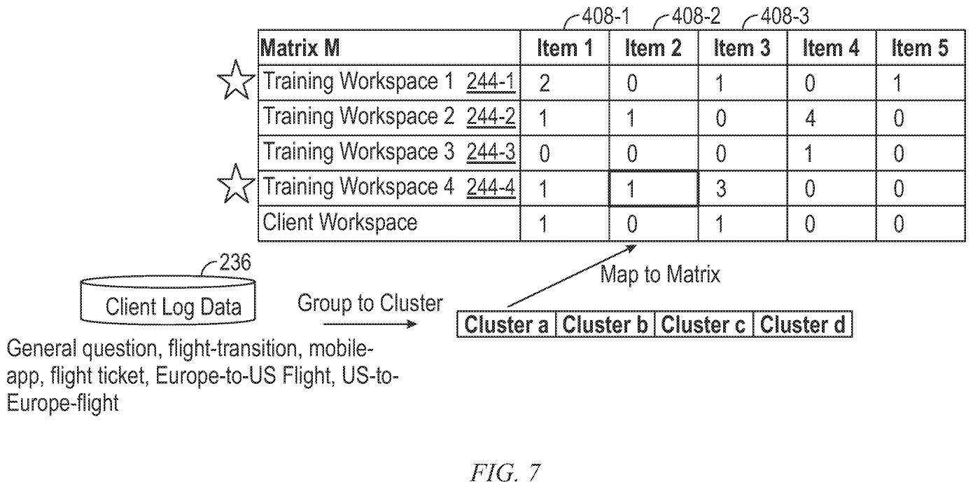

FIG. 5 is an example method 500 for generating a recommendation for an intent 216, in accordance with example embodiments. In one example embodiment, a given client workspace 232 is mapped into the matrix M following the building process of the initial matrix (operation 504). FIG. 6 is an example of a built matrix M being updated with a grouping of intents 216 into corresponding items 408-1, 408-2, 408-3 for a corresponding client workspace 232, in accordance with example embodiments. As illustrated in FIG. 6, the intent “book-flight” is mapped to item 1 (item 408-1) and the intent “cancel-flight” is mapped to item 3 (item 408-3).

In one example embodiment, a search is conducted for a training workspace(s) 244-1, 244-2, 244-3, 244-4 that contains a similar set of items 408-1, 408-2, 408-3 in the matrix compared to the given client workspace 232 (operation 508). As illustrated in FIG. 6, two training workspaces 244-1, 244-2, 244-3, 244-4 (identified with stars; training workspace 1 and training workspace 2) have a similar group of items 408-1, 408-2, 408-3 compared with the client workspace 232. In one example embodiment, the search is as follows: a cosine similarity between the given client workspace 232 and training workspaces 244-1, 244-2, 244-3, 244-4 is computed. The top-k most relevant workspaces will be selected. If k=2, the most similar workspaces will be training workspace 1 (training workspace 244-1) and training workspace 4 (training workspace 244-4).

In one example embodiment, the user utterances 212 of the client log data 236 are grouped into clusters and the clusters are mapped into items 408-1, 408-2, 408-3 of the similar training workspaces 244-1, 244-2, 244-3, 244-4 using the corresponding embeddings (operation 512). FIG. 7 shows results of grouping the user utterances 212 of the client log data 236 and mapping the clusters into items 408-1, 408-2, 408-3 of the similar training workspaces 244-1, 244-2, 244-3, 244-4, in accordance with example embodiments. As illustrated in FIG. 7, client log data 236 are grouped into clusters a, b, c, d. One of the clusters (cluster a) can be mapped into item 408-2 (item 2), which is also in one of the similar training workspaces 244-4 (training workspace 4).

In one example embodiment, the mapped items 408-1, 408-2, 408-3 (and corresponding intents 216) that exist in the similar training workspace(s) 244-1, 244-2, 244-3, 244-4, but not in the client workspace 232, are recommended (operation 516). As illustrated in FIG. 7, the mapped item 408-2 (and corresponding intents 216 in item 408-2), which exist in the similar training workspace 244-4, but not in the client workspace 232, are recommended to the client.

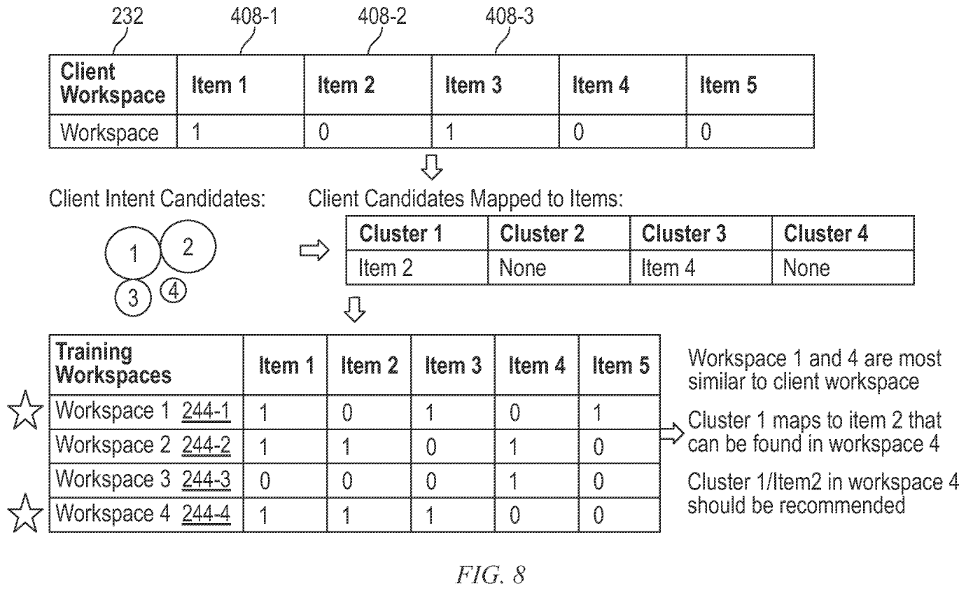

FIG. 8 illustrates an overall workflow for generating recommendations of intents 216, in accordance with example embodiments. As illustrated in FIG. 8, a given client workspace 232 is mapped into the matrix M following the matrix building process (operation 504), a cosine similarity is calculated for a training workspace(s) 244-1, 244-2, 244-3, 244-4 against the client workspace 232 that contains a similar set of items in the matrix compared to the given client workspace 232 (operation 508), user utterances 212 of the client log data 236 are grouped into clusters and the clusters are mapped into items 408-1, 408-2, 408-3 of the similar training workspace(s) 244-1, 244-2, 244-3, 244-4 using the corresponding embeddings (operation 512), and four clusters are identified. For the four clusters, only two of them mapped to an item in the item-2-customer matrix. The log data that are mapped into item 2 existing in the similar training workspace(s) 244-1, 244-2, 244-3, 244-4, but not in the client workspace 232, are recommended (operation 516).

### Variant Approaches

### Recommendations Based on a Client Workspace

In one example embodiment, recommendations are enabled without using client log data 236. After mapping the client workspace 232 into the matrix M and finding a similar training workspace 244-1, 244-2, 244-3, 244-4, items 408-1, 408-2, 408-3 (and the corresponding intents 216) that exist in the similar training workspace(s) 244-1, 244-2, 244-3, 244-4, but not in the client workspace 232, are recommended to the client.

### Recommendations Based on New User Logs

In one example embodiment, recommendations based on client log data 236 are enabled without creating the client workspace 232 by instead utilizing a user-provided client workspace 232. Without mapping the client workspace 232, this approach maps a user's log or the user's clusters into items 408-1, 408-2, 408-3 in matrix M, and recommends the mapped items 408-1, 408-2, 408-3 (and the corresponding intents 216) to the client.

Given the discussion thus far, it will be appreciated that, in general terms, an exemplary method, according to an aspect of the invention, includes the operations of encoding, using at least one hardware processor, a first intent 216 from customer provided data as an intent embedding (operation 304); comparing, using the at least one hardware processor, the intent embedding of the first intent 216 and an intent embedding corresponding to one or more items 408-1 of a training workspace 244-1, 244-2, 244-3, 244-4 to generate a similarity score (operation 308); mapping, using the at least one hardware processor, the first intent 216 to a similar item 408-1 of the one or more items 408-1 and incrementing a corresponding count of the similar item 408-1 by one in response to the similarity score being greater than a given threshold (operation 312); creating, using the at least one hardware processor, a matrix based on the similarity score, the created matrix including selected training workspaces; training at least a first machine learning model using one or more of the selected training workspaces 244-1, 244-2, 244-3, 244-4 of the created matrix; training, using the at least one hardware processor, at least a second machine learning model using the created matrix; and facilitating deployment of the at least second machine learning model for performing inferencing.

Regarding what models are being trained, to be precise, it should be noted that at least one machine learning model is trained for each training workspace and at least one recommendation system (machine learning) model is trained based on the created matrix.

In one example embodiment, inferencing is performed using the deployed at least second trained machine learning model.

In one example embodiment, the comparing operation is repeated and a new item 408-1 corresponding to a second intent 216 is created in response to the similarity score being less than the given threshold and a count corresponding to the new item 408-1 is set to one (operation 316).

In one example embodiment, client log data 236 is clustered into candidate intents 216 and the candidate intents 216 are mapped to the items 408-1 of the matrix; and at least one intent recommendation is created based on intents 216 corresponding to the items 408-1 of the training workspace 244-1, 244-2, 244-3, 244-4.

In one example embodiment, the comparing operation further comprises performing a check to determine is there exists an existing item 408-1 with a similarity (intent_embeddingᵢ, item_embeddingⱼ) that is greater than the given threshold (operation 308).

In one example embodiment, the encoding, comparing, mapping, creating the new item 408-1, and creating the matrix operations are repeated for each workspace 244-1, 244-2, 244-3, 244-4 to update the matrix with each pair of training workspace 244 and item 408-1.

In one example embodiment, a given client workspace 232 is mapped into the matrix (operation 504); a search of the training workspace 244-1, 244-2, 244-3, 244-4 that contains a similar set of items 408-1, 408-2, 408-3 compared to the given client workspace 232 is conducted (operation 508); utterances 212 of client log data 236 are grouped into clusters and the clusters are mapped into items 408-1, 408-2, 408-3 of the similar training workspaces 244-1, 244-2, 244-3, 244-4 using the corresponding embeddings (operation 512); and the first and second intents 216 corresponding to the mapped items 408-1, 408-2, 408-3 that exist in the similar training workspace 244-1, 244-2, 244-3, 244-4 and are absent from the client workspace 232 are recommended (operation 516).

In one example embodiment, a given client workspace 232 is mapped into the matrix (operation 504); a search of the training workspace(s) 244-1, 244-2, 244-3, 244-4 that contain a similar set of items 408-1, 408-2, 408-3 in the matrix compared to the given client workspace 232 is conducted (operation 508); and the first and second intents 216 corresponding to the mapped items 408-1, 408-2, 408-3 that exist in the similar training workspace 244-1, 244-2, 244-3, 244-4 and are absent from the client workspace 232 are recommended (operation 516).

In one example embodiment, utterances 212 of client log data 236 are grouped into clusters and the clusters are mapped into items 408-1, 408-2, 408-3 of the training workspace 244-1, 244-2, 244-3, 244-4 using the corresponding embeddings (operation 512); and the first and second intents 216 corresponding to the mapped items 408-1, 408-2, 408-3 that exist in the training workspace 244-1, 244-2, 244-3, 244-4 are recommended (operation 516).

In one example embodiment, the inferencing is performed to generate a recommendation for a conversational artificial intelligence task.

In one aspect, a computer program product comprises one or more tangible computer-readable storage media and program instructions stored on at least one of the one or more tangible computer-readable storage media, the program instructions executable by a processor, the program instructions comprising encoding a first intent 216 from customer provided data as an intent embedding (operation 304); comparing the intent embedding of the first intent 216 and an intent embedding corresponding to one or more items 408-1 of a training workspace 244-1, 244-2, 244-3, 244-4 to generate a similarity score (operation 308); mapping the first intent 216 to a similar item 408-1 of the one or more items 408-1 and incrementing a corresponding count of the similar item 408-1 by one in response to the similarity score being greater than a given threshold (operation 312); creating a matrix based on the similarity score, the created matrix including selected training workspaces; training at least a first machine learning model using one or more of the selected training workspaces 244-1, 244-2, 244-3, 244-4 of the created matrix; training, using the at least one hardware processor, at least a second machine learning model using the created matrix; and facilitating deployment of the at least second machine learning model for performing inferencing.

In one aspect, an apparatus comprises a memory and at least one processor, coupled to the memory, and operative to perform operations comprising encoding a first intent 216 from customer provided data as an intent embedding (operation 304); comparing the intent embedding of the first intent 216 and an intent embedding corresponding to one or more items 408-1 of a training workspace 244-1, 244-2, 244-3, 244-4 to generate a similarity score (operation 308); mapping the first intent 216 to a similar item 408-1 of the one or more items 408-1 and incrementing a corresponding count of the similar item 408-1 by one in response to the similarity score being greater than a given threshold (operation 312); creating a matrix based on the similarity score, the created matrix including selected training workspaces; training at least a first machine learning model using one or more of the training workspaces 244-1, 244-2, 244-3, 244-4 of the created matrix; training, using the at least one hardware processor, at least a second machine learning model using the created matrix; and facilitating deployment of the at least second machine learning model for performing inferencing.

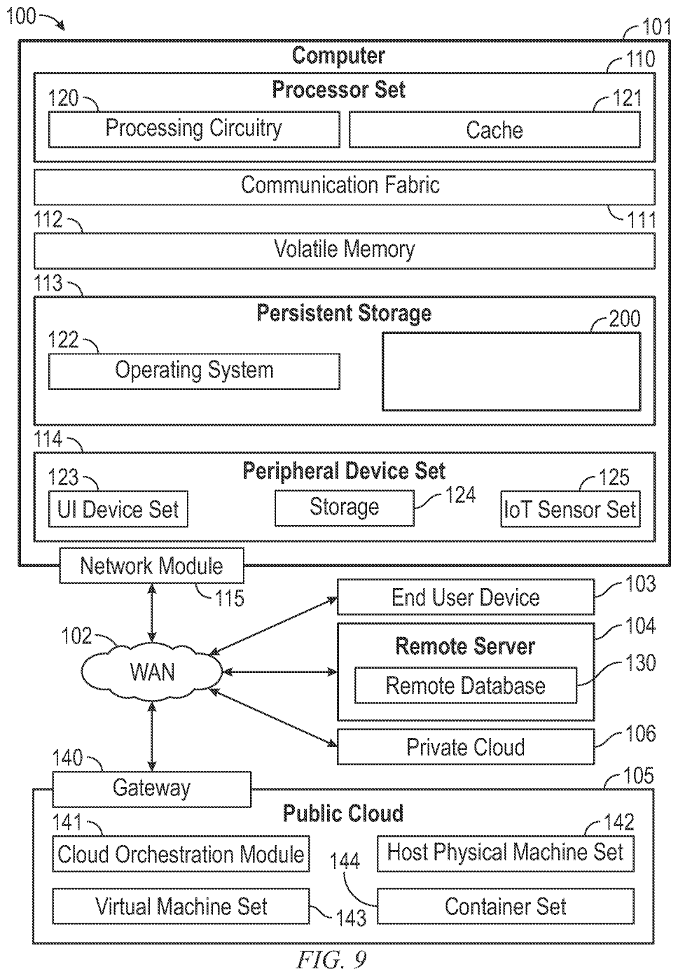

Refer now to FIG. 9.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as conversational artificial intelligence system 200 implementing, for example, recommendations as described herein. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method comprising:
encoding, using at least one hardware processor, a first intent from customer provided data as an intent embedding;
comparing, using the at least one hardware processor, the intent embedding of the first intent and an intent embedding corresponding to one or more items of a training workspace to generate a similarity score;
mapping, using the at least one hardware processor, the first intent to a similar item of the one or more items and incrementing a corresponding count of the similar item by one in response to the similarity score being greater than a given threshold;
creating, using the at least one hardware processor, a matrix based on the similarity score, the created matrix including selected training workspaces;
training, using the at least one hardware processor, at least a first machine learning model using one or more of the selected training workspaces of the created matrix;
training, using the at least one hardware processor, at least a second machine learning model using the created matrix; and
facilitating, using the at least one hardware processor, deployment of the at least second machine learning model for performing inferencing.

2. The method of claim 1, further comprising performing inferencing using the deployed at least second trained machine learning model.

3. The method of claim 1, further comprising repeating the comparing operation and creating a new item corresponding to a second intent in response to the similarity score being less than the given threshold and setting a count corresponding to the new item to one.

4. The method of claim 3, further comprising:
clustering client log data into candidate intents and mapping the candidate intents to the items of the matrix; and
creating at least one intent recommendation based on intents corresponding to the items of the training workspace.

5. The method of claim 3, wherein the comparing operation further comprises
performing a check to determine is there exists an existing item with a similarity (intent_embeddingᵢ, item_embeddingⱼ) that is greater than the given threshold.

6. The method of claim 3, further comprising repeating the encoding, comparing, mapping, creating the new item, and creating the matrix operations, for each workspace to update the matrix with each pair of training workspace and item.

7. The method of claim 3, further comprising:
mapping a given client workspace into the matrix;
conducting a search of the training workspace that contains a similar set of items compared to the given client workspace;
grouping utterances of client log data into clusters and mapping the clusters into items of the similar training workspaces using the corresponding embeddings; and
recommending the first and second intents corresponding to the mapped items that exist in the similar training workspace and are absent from the client workspace.

8. The method of claim 3, further comprising:
mapping a given client workspace into the matrix;
conducting a search of the training workspace(s) that contain a similar set of items in the matrix compared to the given client workspace; and
recommending the first and second intents corresponding to the mapped items that exist in the similar training workspace and are absent from the client workspace.

9. The method of claim 3, further comprising:
grouping utterances of client log data into clusters and mapping the clusters into items of the training workspace using the corresponding embeddings; and
recommending the first and second intents corresponding to the mapped items that exist in the training workspace.

10. The method of claim 2, wherein the inferencing is performed to generate a recommendation for a conversational artificial intelligence task.

11. A computer program product, comprising:
one or more tangible computer-readable storage media and program instructions stored on at least one of the one or more tangible computer-readable storage media, the program instructions executable by a processor, the program instructions comprising:
encoding a first intent from customer provided data as an intent embedding;
comparing the intent embedding of the first intent and an intent embedding corresponding to one or more items of a training workspace to generate a similarity score;
mapping the first intent to a similar item of the one or more items and incrementing a corresponding count of the similar item by one in response to the similarity score being greater than a given threshold;
creating a matrix based on the similarity score, the created matrix including selected training workspaces;
training at least a first machine learning model using one or more of the selected training workspaces of the created matrix;
training, using the at least one hardware processor, at least a second machine learning model using the created matrix; and
facilitating deployment of the at least second machine learning model for performing inferencing.

12. A system comprising:
a memory; and
at least one processor, coupled to said memory, and operative to perform operations comprising:
encoding a first intent from customer provided data as an intent embedding;
comparing the intent embedding of the first intent and an intent embedding corresponding to one or more items of a training workspace to generate a similarity score;
mapping the first intent to a similar item of the one or more items and incrementing a corresponding count of the similar item by one in response to the similarity score being greater than a given threshold;
creating a matrix based on the similarity score, the created matrix including selected training workspaces;
training at least a first machine learning model using one or more of the selected training workspaces of the created matrix;
training at least a second machine learning model using the created matrix; and
facilitating deployment of the at least second machine learning model for performing inferencing.

13. The system of claim 12, the operations further comprising performing inferencing using the deployed at least second trained machine learning model.

14. The system of claim 12, the operations further comprising repeating the comparing operation and creating a new item corresponding to a second intent in response to the similarity score being less than the given threshold and setting a count corresponding to the new item to one.

15. The system of claim 14, the operations further comprising:
clustering client log data into candidate intents and mapping the candidate intents to the items of the matrix; and
creating at least one intent recommendation based on intents corresponding to the items of the training workspace.

16. The system of claim 14, wherein the comparing operation further comprises
performing a check to determine is there exists an existing item with a similarity (intent_embeddingᵢ, item_embeddingⱼ) that is greater than the given threshold.

17. The system of claim 14, the operations further comprising repeating the encoding, comparing, mapping, creating the new item, and creating the matrix operations, for each workspace to update the matrix with each pair of training workspace and item.

18. The system of claim 14, the operations further comprising:
mapping a given client workspace into the matrix;
conducting a search of the training workspace that contains a similar set of items compared to the given client workspace;
grouping utterances of client log data into clusters and mapping the clusters into items of the similar training workspaces using the corresponding embeddings; and
recommending the first and second intents corresponding to the mapped items that exist in the similar training workspace and are absent from the client workspace.

19. The system of claim 14, the operations further comprising:
mapping a given client workspace into the matrix;
conducting a search of the training workspace(s) that contain a similar set of items in the matrix compared to the given client workspace; and
recommending the first and second intents corresponding to the mapped items that exist in the similar training workspace and are absent from the client workspace.

20. The system of claim 14, the operations further comprising:
grouping utterances of client log data into clusters and mapping the clusters into items of the training workspace using the corresponding embeddings; and
recommending the first and second intents corresponding to the mapped items that exist in the training workspace.
